(19) United States
(12) Patent Application Publication
(10) Pub. No.: US 2005/0075164 A1
(43) Pub. Date: Apr. 7, 2005

(54) Method of wagering and associated system

(75) Inventor: Joseph Krynicky, Roselle, NJ (US)

Correspondence Address: Shawn A. McClintic;Renner, Otto, Boisselle & Sklar, LLP, Nineteenth Floor, 1621 Euclid Avenue, Cleveland, OH, 44115-2191, US

(73) Assignee: Football Exacta LLC, Roselle, NJ (US)

(21) Appl. No.: 10/949,510

(22) Filed: Sep. 24, 2004

Related U.S. Application Data
(63) Continuation-in-part of application No. 10/208,610, filed on Jul. 30, 2002.

(51) Int. Cl. G06F 19/00; G06F 17/00

(52) U.S. Cl. 463/25

(57) ABSTRACT

A method of wagering is provided. The method includes determining a wager by selecting at least two participants or teams from a plurality of participants or a plurality of teams, respectively, and selecting a metric associable with the selected participants or teams. The earned metric value of each of the plurality of participants or teams is determined. A wager status is determined by comparing the earned metric value of the selected participants or teams relative to earned metric values of the plurality of participants or teams.

### CROSS-REFERENCE TO RELATED APPLICATIONS

This continuation-in-part application claims priority to U.S. patent application Ser. No. 10/208,610, which is hereby incorporated by reference in its entirety.

### BACKGROUND OF THE INVENTION

1. Field of Invention

The present invention generally relates to a method for wagering and an associated system.

2. Discussion of Related Art

There are numerous types of betting, gambling, gaming, games of chance, or wagering (collectively “wagering” hereinafter). For example, wagering may be a pari-mutuel type sometimes referred to as para-mutual, or may be a fixed-odds type. A pari-mutuel wager may pool money from bettors. After the wager, winning bettors share the total money in the pool minus a commission amount. That is, bettors compete among themselves for portions of a common pool of funds, which is formed from moneys on wagers supplied by the bettors. Some pari-mutuel wagering includes horseracing, dog racing, jai alai, and other sporting events. Pari-mutuel wagering is suitable for events of relatively short duration and in which participants finish in a ranked order.

Fixed-odds wagering may be against odds offered by a bookmaker, an individual, or on a bet exchange (collectively hereinafter “the house”). Sometimes fixed-odds wagering determines expected odds at the time of the placement of the wager, however this category may accommodate events in which wagers are struck at “starting price”. The house may price up a book such that the net outcome will always be in his favor, i.e. the sum of all possible outcomes will be in excess of 100%. The amount of the sums wagered in excess of 100% represent profit to the house in the event of a balanced book. This excess may be referred to as “overround.”

With respect to a particular event, such as football, the house may set a point spread to attract a predetermined quantity of wagering for each competing football team. A point spread is a point handicap placed against the perceived stronger team. Without the point spread, reasonable bettors would only place bets on the heavily favored teams, and there would be no bets on the heavily disfavored teams. With other sports, odds are conventionally set that have a higher level of payout for the perceived weaker team in an attempt to maintain a balance between wagers on both sides. The house may attempt to divide the betting money into offsetting groups to hedge the risk to the house and maintain profitability.

Some bettors may be drawn to new and/or different forms of gaming or wagering. More exotic betting opportunities may be sometimes desirable. Thus, different forms of gaming or wagering may be desirable. In addition, different methods and/or systems for implementing gaming or wagering may be desirable.

### SUMMARY OF THE INVENTION

The present invention relates to methods of wagering. The invention may also relate to a system for wagering, a method of doing business that involves wagering, and a computer readable medium that includes algorithms related to wagering.

An embodiment of the present invention relates to a method of wagering. The method may include determining a wager, which may include selecting at least two teams from a plurality of teams, and selecting a metric associable with each of the plurality of teams. The method further may include determining an earned metric value respective to each of the plurality of teams, and determining a wager status by comparing the earned metric values of each of the at least two selected teams relative to the earned metric values of each of the plurality of teams.

Another embodiment of the present invention relates to a method of wagering. The method may include determining a wager, which may include selecting at least two participants from a plurality of participants, and selecting a metric associable with each of the plurality of participants. The method further may include determining an earned metric value respective to each of the plurality of participants, and determining a wager status by comparing the earned metric values of each of the at least two selected participants relative to the earned metric values of each of the plurality of participants.

These and other aspects of the present invention may be apparent with reference to the description and the drawing figures disclosed herein.

### BRIEF DESCRIPTION OF THE DRAWINGS

FIG. 1 is a schematic block diagram showing a method comprising an embodiment in accordance with the invention.

FIG. 2 is a schematic block diagram showing a method comprising another embodiment in accordance with the invention.

FIG. 3 is a schematic block diagram showing a method comprising another embodiment in accordance with the invention.

FIG. 4 is a schematic block diagram showing a method comprising another embodiment in accordance with the invention.

FIG. 5 is a schematic block diagram showing a system comprising an embodiment in accordance with the invention.

FIGS. 5A-5E are schematic block diagrams each showing a portion of the system shown in FIG. 5.

FIG. 6 is a schematic block diagram showing a method comprising an embodiment in accordance with the invention.

### DESCRIPTION OF PREFERRED EMBODIMENTS

Generally, the present invention relates to wagering of bettors. More particularly, an embodiment of the present invention relates to a method of wagering. Embodiments may also relate to a system for wagering, a method of doing business that involves wagering, and a computer readable medium that includes algorithms related to wagering.

As used herein, a “wager” may be an agreement having terms under which a bettor may pledge a sum of money or “payment amount” to receive or remit depending on the outcome of an unsettled matter. A wager may be sometimes referred to as a bet, therefore the “bettor” may participate in the wager. A “wager status” may be the outcome of the wager. For example, the better may be obligated to provide the payment amount for a losing wager status, or may be entitled to receive the payment amount for a winning wager status, or may be entitled to something else, such as may be the case with a draw wager status which may end the wager without winning or losing, or a carryover wager status in which the wager may remain in effect until the outcome of some additional event. The outcome of the additional event (e.g., tiebreaker or double-or-nothing) may continue the wager, precipitate the payment of a portion of the payment amount, end the wager, or otherwise modify the wager in some manner, for example, may form a ‘kicker’, bonus, or payout enhancer/reducer.

The nature, terms, or bounds of a wager according to an embodiment of the invention may include the comparison of metrics or the earned metric value for a participant, position, team, game, game set, and/or event. A “metric” may be a determinable and measurable standard associated with a participant, position, team, game, game set, and/or event. Once the metric has been determined, for example, once a game has been played and the selected metric has been measured, the “earned metric value” may be ascertained. For example, a metric may be a score for a team during a game, after the game has been played, the teams score for that game may be the earned metric value. Metrics and the like are described in further detail hereinbelow.

A “position” is a job or task for which a particular player or “participant” may be responsible in a given event. Each game may have one or more participants in opposition to each other. Thus, each opposing interest in a game is a “team” that may have one or more participants that hold predefined positions in a game of an event. A “game” is an instance of an event in which players contend with each other according to a set of rules. In the singular form, a “game” is single instance of such an event. “Games” refers to a plurality of instances of a game. A set of games or “game set” may include games from one or more events. For example, a game set may include three games including a game of basketball, a game of football and a game of hockey.

An “event” is an activity that may be competitive and may be accompanied by exertion, physical, mental, mechanical, or otherwise, and is governed by a recognizable set of rules or customs. As used herein, the singular, “event” involves a single type of activity that can be differentiated from other types of similar or dissimilar activities. Generally, an event may include a plurality of games and/or game sets. However, a “plurality of participants,” a “plurality of teams,” a “plurality of games,” and a “plurality of game sets,” as used herein, may not imply a single event, but may be selected from a single event in some embodiments.

Also, boundaries of a wager may be defined by determining the contents or members of a “plurality of participants,” a “plurality of teams,” a “plurality of games,” and/or a “plurality of game sets” from which the bettor may select respective participants, teams, etc. For example, a “virtual game” may be created in accordance with embodiments of the invention by selecting teams which may not compete against one another in an actual “game.” In such a virtual game, the plurality of teams may be defined that constitute the virtual game, and from which the bettor may select teams and a metric associable or associated with each of the participating teams that make up the plurality of teams.

The metrics may be associated with a position, a participant, a team, a game, a game set, an event, or combinations or two or more thereof, and the like. Suitable metrics may include score, time, yardage, position, ranking, order or placement, occurrence, combinations of two or more thereof, and the like. For example, a time of possession for a basketball team in a basketball game may be a metric, a score for a dart game may be a metric, and the game score, the world ranking and the tournament ranking for a chess player may each be metrics. Additionally, the winner of a game, a particular team's score, or the winning or losing score by a team or a participant may be a metric. These metrics may be used alone or may be added to other metrics to form combined metrics.

With reference to combined metrics, for example, the combined scores of a hockey team in a hockey game and a soccer team in a soccer game may be totaled or aggregated to form a combined metric. Distance gained by passing, rushing, or both passing and rushing by a participant or football team in a football game may be combined as a metric. A placement of a dog in a dog race and a horse in a horse race as well as the lap times may be combined to form a metric. The number of runs-batted-in (RBI) by a participant or a baseball team in a baseball game may be a metric.

An embodiment according to the invention may include determining a wager status by comparing earned metric values of the selected participants or teams for the preselected metrics against the earned metric values for a larger pool of participants or teams that make up the wager boundary or virtual game. The determination may also include creating a finishing order or ranking for all the participants or teams in the virtual game. Table 1 shows a list of possible determinations useful for some alternative embodiments of the invention.

TABLE 1
Selection scenarios for alternative embodiments.

Bettor must pick a single participant or team that ranks in a
predetermined position when ranked against all the other
participants or teams from which the participant or team
is selected. (E.g., the highest rank or the lowest rank)
Bettor must pick a participant or team that finishes in a
range of finishing spots, and define the range. (E.g., first
or second, or top three).
Bettor must pick a total of two of the participants, teams,
or combination that finish in a range of finishing spots, and
pick the range, but the bettor need not specify the order.
(E.g., first and last place, or first and second place).
Bettor must pick a total of two of the participants, teams, or a
combination that finish in a range of finishing spots, and pick
the range, and must specify the order in which they finish in that
range. (E.g., first place and second place and which will be first)
Bettor must pick more than two of the participants, teams, or a
combination, and the range, and may specify which will finish
in what positions relative to each other.
Bettor must pick more than two of the participants, teams, or a
combination, and the range, and not specify which will finish
in what positions relative to each other, just that those
selected will be in the range selected.
Any of the above scenarios, but the range is provided to the
bettor, and the bettor does not have input as to the range.
(E.g., house selects the range to be participants or teams or
combination with the highest three earned metric values)
Any of the above scenarios, but the pool of participants or
teams is provided to the bettor, and the bettor does not have
input as to the pool. (E.g., house selects the participants
or teams or combination from which the bettor may select)

Finishing order or ranking may be used in some embodiments according to the invention as a supplemental metric in a combined metric instance. The finishing order or ranking in this case may be different than the ordering of picked or selected teams or participants relative to all of the teams or participants in that form the plurality or pool from which the teams or participants are selected. In the one sense, the finishing order or ranking of a dog in a dog race may be a traditional determination of the winning dog in the race. That is, the first dog to finish may be the first place winner. Such a designation should not be confused with a finishing order or ranking based on comparing the earned metric values of all the teams or participants in the plurality or pool, as used in an embodiment of the invention.

In an embodiment, a bettor or the house may define or determine a wager based on selecting multiple metrics or multiple combined metrics. An example of a wager on multiple metrics may include a box wager. A “box wager” may be a combined metric wager in which all possible combinations of a defined group of metrics are used to define or determine the wager. A “key wager” may be a combined metric wager in which a single finishing order for the earned metric values in a preselected game, game set, or event may be included in the wager to determine a wager status; the single finishing order may be compared to all possible combinations of other metrics in a single game, game set, or event.

A wager status according to an embodiment of the invention may be determined by comparing earned metric values of the selected participants or teams against a spread, against odds, or against a combination of odds and spread. In a wager against the spread, the bettor may wager either that the selected team(s) and/or participant(s) will score an earned metric value that differs from a pre-selected metric value by a specified number of points, or that it will not differ by the number of points. The pre-selected value may be determined by, for example, defining a second, different selected team(s) and/or participant(s) from the plurality or pool, or from an average earned metric value determined by the earned metric values of the contents of the plurality or pool (may also include median or mode and the like rather than average), or from an absolute value pre-determined at the start of the wager. In a wager against odds, the wager may be that the selected team(s) and/or participant(s) will earn a relatively higher earned metric value relative to all the others of the plurality or pool even though not favored to do so. An over-under wager may be based on combined metrics. In making an over-under wager, a bettor may wager that the total or aggregate of selected earned metric values (the combined metrics) will be higher or lower than a total metric amount pre-specified by the house.

In embodiments of the invention, a metric may be measured, and the earned metric value measured therefrom may be modified by using weighting, handicapping, conversion factors, combinations thereof, and the like. The weighting, handicapping, and conversion factors may be selected based on objective criteria, subjective criteria, or both object criteria and subjective criteria. Weighting, for example, may include factors that directly or indirectly form part of the wager determination. Direct factors may include team or participant expected performance and/or past performance statistic, injury list, and/or strength of schedule, combinations thereof, and the like. Indirect factors may include weather and the like.

A conversion factor may be used to compare like unit metrics or dissimilar unit metrics. Like metrics may include distance to distance comparison, or time to time comparison. Goal in hockey and goal in soccer may be considered like unit comparisons. For example, the number of goal a particular soccer team may score in a particular game of soccer may be compared to the number of goals a particular hockey team may score in a particular game of hockey. While one soccer goal is not the same as one hockey goal, as each are “goals” of a sort, they may be considered like unit metrics herein. The conversion for the earned metric values may be (1 soccer goal=1 hockey goal). The conversion factor may be weighted to account for such items as disparities in scoring or in performances. For example, a 100 meter sprint and a marathon may be both measured in units of time. But, the sprint may always be less time, unless balanced using a weighting. If a sprint time for a sprint event participant has been averaging about 25 seconds per game, and a marathon time for a marathon event participant has been averaging about 250 minutes, then a conversion of sprint time to marathon time, with a weighting may be made, for example, relative to the average times of each of the participants. That is, the conversion factor may be weighted with a relation of a particular metric to an average metric for a pre-selected metric unit, in this instance, the amount of time.

In addition, the conversion factor may be used to convert from one type of metric to another type of metric. For example, if the average number of points scored per game by a particular basketball player or by a participant in a position on a basketball team may be 30 points per game, and the average number of goals scored per game by a particular hockey player or by a participant in a position on a hockey team is 3 goals per game. These may be dissimilar metric units as a goal may not be a point, necessarily. However, a conversion factor of 30 basketball points to 3 hockey goals (10:1) may be used to determine a wager status where the wager compares the number of points in a basketball game to the number of goals in a hockey game relative at least to the particular players or the particular positions on the respective teams.

A prudent bettor also may consider the strengths or weaknesses of, for example, the teams opposing the teams from which the metrics are to be measured. But, at least in this example, it may be possible for a wager to be made between a participant in one event, and a participant in a different event. Weighting, point spreads and the like also may be used to redistribute risk or even the likelihood of wager outcomes.

In an American-style football event, for example, a game set may include the all the playoff games, and in any particular playoff game there may be two teams, each team may have multiple positions, and each position may have an associated participant. The position in one game of one event may be about the same as the position in a different game in the same event. For example, a quarterback position in one American-style football game may be about the same as a quarterback position in another American-style football game. Conversely, different positions in the same game, the same event, or in different events may not be the same but may have comparable performance statistics for use as a metric. For example, a lap time in horseracing may not be the same as a lap time in NASCAR racing, but using conversion factors, weighting, or the like the lap times may be useful as metrics to determine a wager.

In some games, such as dog racing where a dog is the participant, each participant may be considered their own team, and there are many teams competing simultaneously. This may underscore the difficulty in talking separately about teams and participants, and highlight the almost interchangeability of the terms. For example, one event may be the sport of Australian-rules football, while a different event may be the sport of American-style football. An event also may include non-physical, minimally-physical, or mental activities, such as international-rules chess. With further reference to international-rules chess, the participants may be human, but also be machine/computer. Other non-human events that may include suitable metrics include insect fighting, and dog and horse racing. Wagers may be defined according to classifications determined by the better, the house or both. For example, all events may be required to have human participants, non-human participants, only human participants, only non-human participants, only mammals, only bipeds or quadrupeds, and so forth. A suitable game set may be selected using wager determining criteria.

In one embodiment, the bettor may select or pick a plurality of teams to obtain an earned metric value for a preselected metric based on the teams participating in aggregated games, game sets, and/or events, and particularly, the bettor picks the plurality of teams so as to achieve the highest earned metric value relative to other comparable pluralities of teams. In one embodiment, the metrics selected may be independent of the win/lose status of the teams of the plurality. The total of the teams (from which the plurality may be selected) may be defined as those teams that may compete or have a game within a particular time period, for example, all the teams of an event competing in a given day, week, or season. The metric selected for comparison may be the points scored by each team or teams within the selected plurality. The wager status may be determined by comparing the earned metric values generated after all the games have concluded, and ranking the earned metric values. The wager status may be determined by the win, lose, draw, ranking, finishing order, or combination of two or more thereof, and the like, of the bettor-selected plurality of teams relative to the total plurality of teams based on the respective earned metric values.

Suitable events may include archery, badminton, baseball, basketball, bobsledding, bowling, boxing, canoeing, croquet, curling, cycling, diving, equestrian, fencing, field hockey, figure skating, fishing, football, freestyle skating, golf, gymnastics, ice hockey, luge, martial arts, motor sports or car racing, power-boating, rowing, rugby, running, sailing, skiing, skydiving, soccer, speed skating, synchro-swimming, table tennis, tennis, track and field, water polo, weight lifting, wrestling, or combinations of two or more thereof. Other suitable events include horse racing, dog racing, robot wars, insect fighting, survival games, Olympic sports, puzzle sports, board games, video games, virtual reality games, word games, paintball and laser tag, combinations thereof, and the like. The above disclosed events may be subdivided if desired. For example, football may include American-style, European-style, Australian-rules and the like, each of which may be an event for purposes of the present invention.

In another embodiment according to the invention, a computer-readable storage medium includes a set of instructions for wagering using a general purpose computer having a user interface. The medium includes an algorithm operable to determine a wager based on selecting a first metric associated with a first position in an event, and for selecting a second metric associated with a second position in the event that is different from the first position, selecting a first metric associated with a first event, and selecting a second metric associated with a second event that is different from the first event, or selecting a first metric associated with a first position in an event, and for selecting a second metric associated with a second position in the event that is different from the first position, and selecting a first metric associated with a first event, and selecting a second metric associated with a second event that is different from the first event. The medium further includes an algorithm operable to determine a wager status of for a bettor relative to the wager.

In another embodiment according to the invention, a method for conducting a business that may include wagering is provided. The method may include determining the wager, accepting the wager with a bettor, determining a wager status relative to the wager, and exchanging payment with the bettor based on the determined wager status.

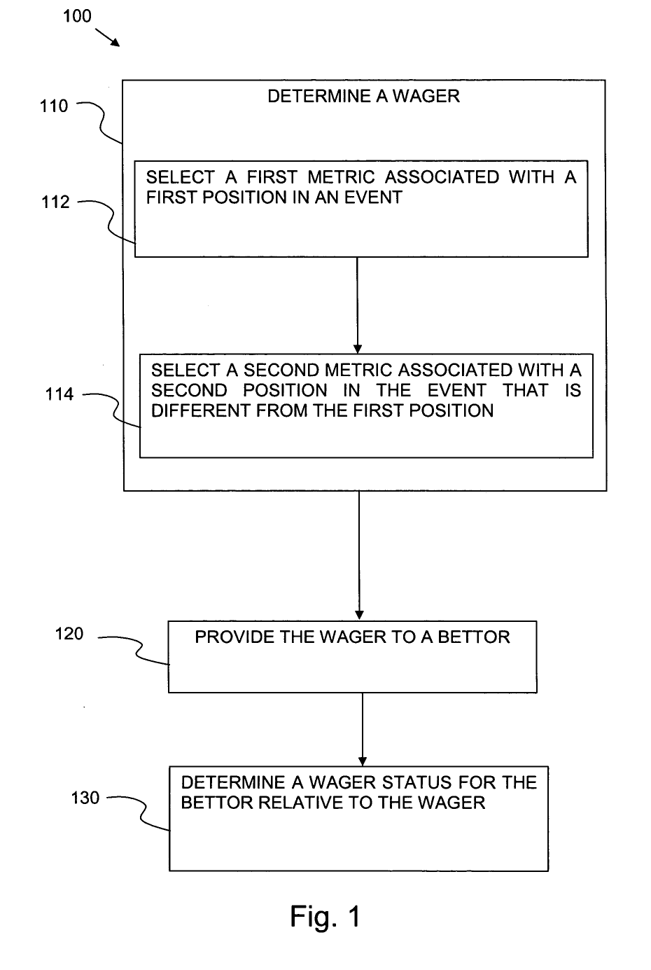

A method of wagering 100 comprising an embodiment according to the present invention is shown in FIG. 1. The method 100 may include determining a wager (step 110) by selecting a first metric associated with a first position in an event (step 112), and selecting a second metric associated with a second position in the event that may be different from the first position (step 114). The wager may be provided to a bettor (step 120). A wager status may be determined (step 130). Optionally, the bettor may then be paid a payment amount, or debited a payment amount, based on the wager status (not shown).

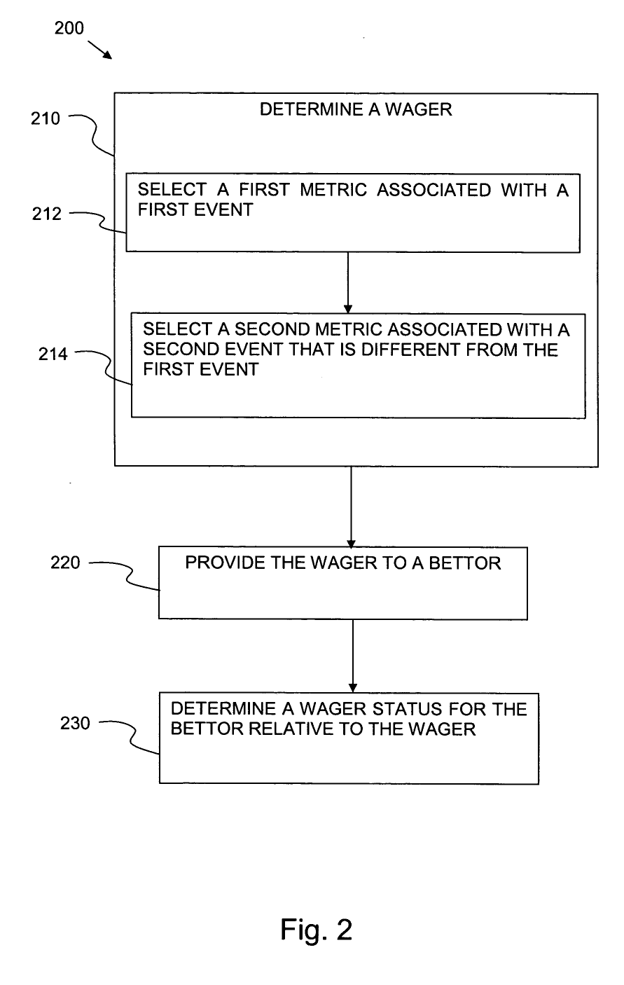

With reference to FIG. 2 and in another embodiment according to the invention, a method of wagering 200 may include determining a wager (step 210). The wager may be determined by selecting a first metric associated with a first event (step 212), and selecting a second metric associated with a second event that may be different from the first event (step 214). The wager may be provided to a bettor (step 220). A wager status may be determined (step 230). Optionally, the bettor may then be paid a payment amount, or debited a payment amount, based on the wager status (not shown).

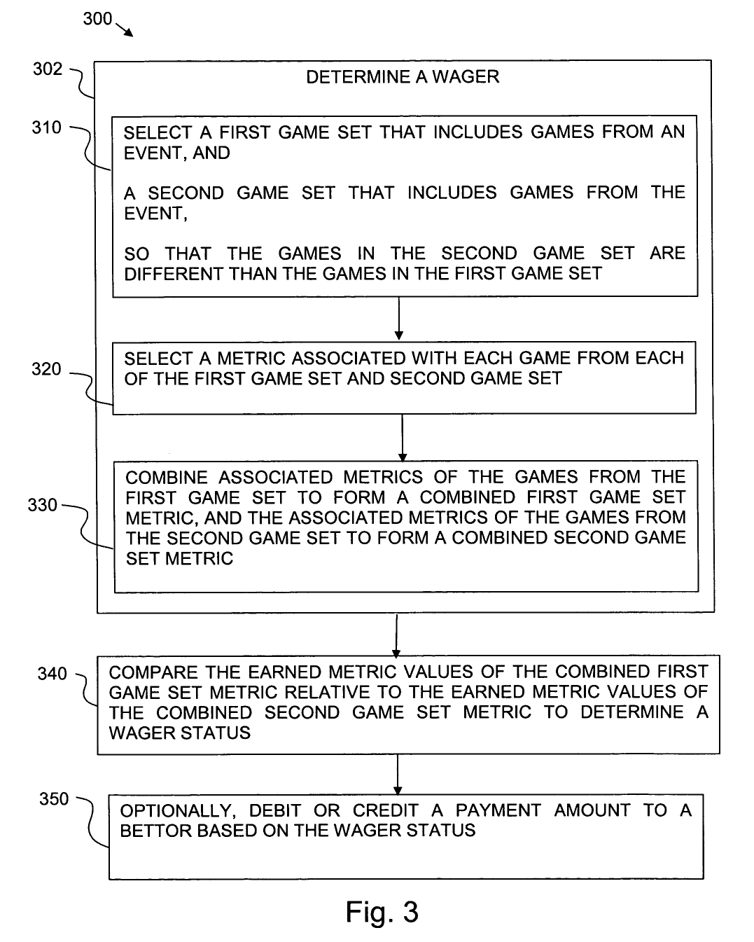

With reference to FIG. 3 and in another embodiment according to the invention, a method of wagering 300 includes determining a wager (step 302). The wager may be determined by selecting a first game set and a second game set (step 310). The first game set may include games from an event. The second game set also may include games from the same event. The two games in the second game set may be different than the games in the first game set. The wager may be determined further by selecting a metric associated with each game of the first game set and the second game set (step 320). The associated metrics of the games for each of the first and second game sets may be combined for each game set to form respective combined game set metrics (step 330).

The method 300 further includes providing the wager to a bettor (not shown). The combined first game set metric may be compared relative to the combined second game set metric to determine a wager status for the bettor relative to the wager (step 340). Optionally, the bettor may then be paid a payment amount, or debited a payment amount, based on the wager status (step 350).

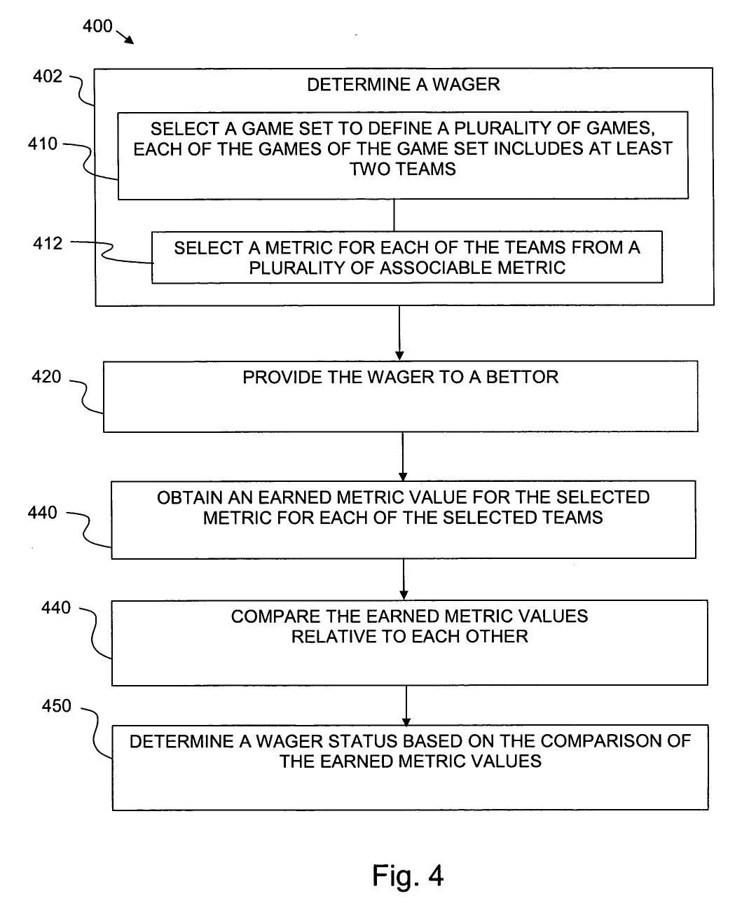

With reference to FIG. 4, a method of wagering 400 includes determining a wager (step 402). The wager may be determined by selecting a game set (step 410). The game set may include a plurality of games. The number of games in each game set may be predetermined, the games in the game set may be determined by a predefined period of time, or by some other like limitation, such as per season, per week, per day, per play off period, and the like. The wager, once determined as to the particulars of the wager—what it may take to win or lose the wager—the wager may be provided to a bettor (step 420). The teams may then compete in the games that are included in the wager, and the metrics may be obtained therefrom (step 440). The metrics may be compared relative to each other (step 440). Optionally or alternatively, the metrics may be compared relative to a standard other than relative to each other (not shown). The wager status may be determined based on the comparison of the metrics (step 450).

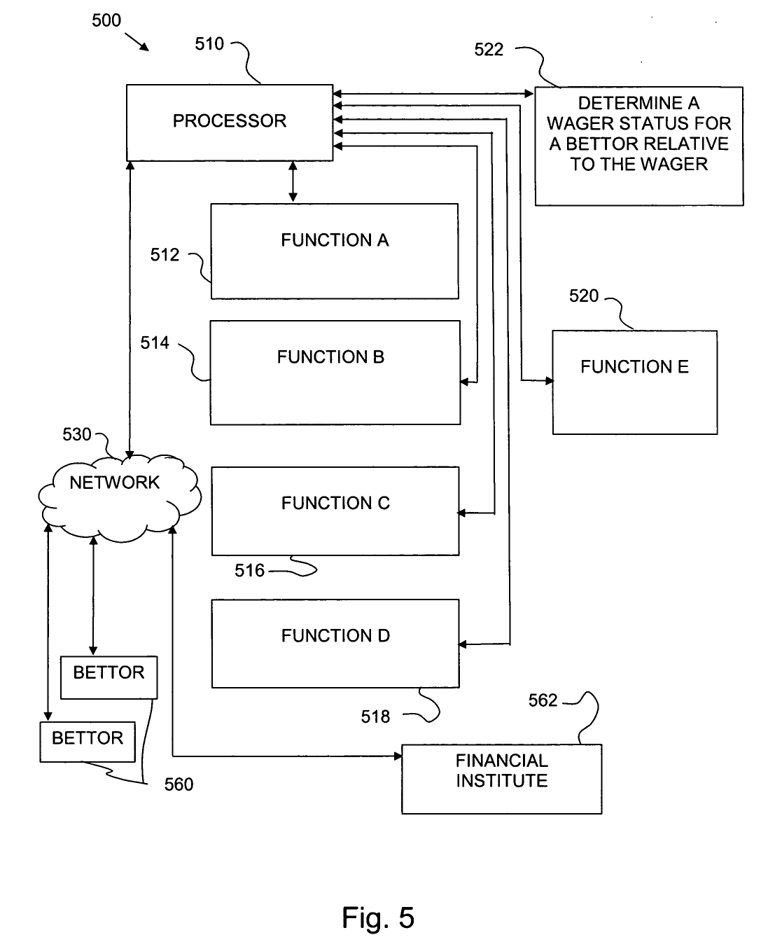

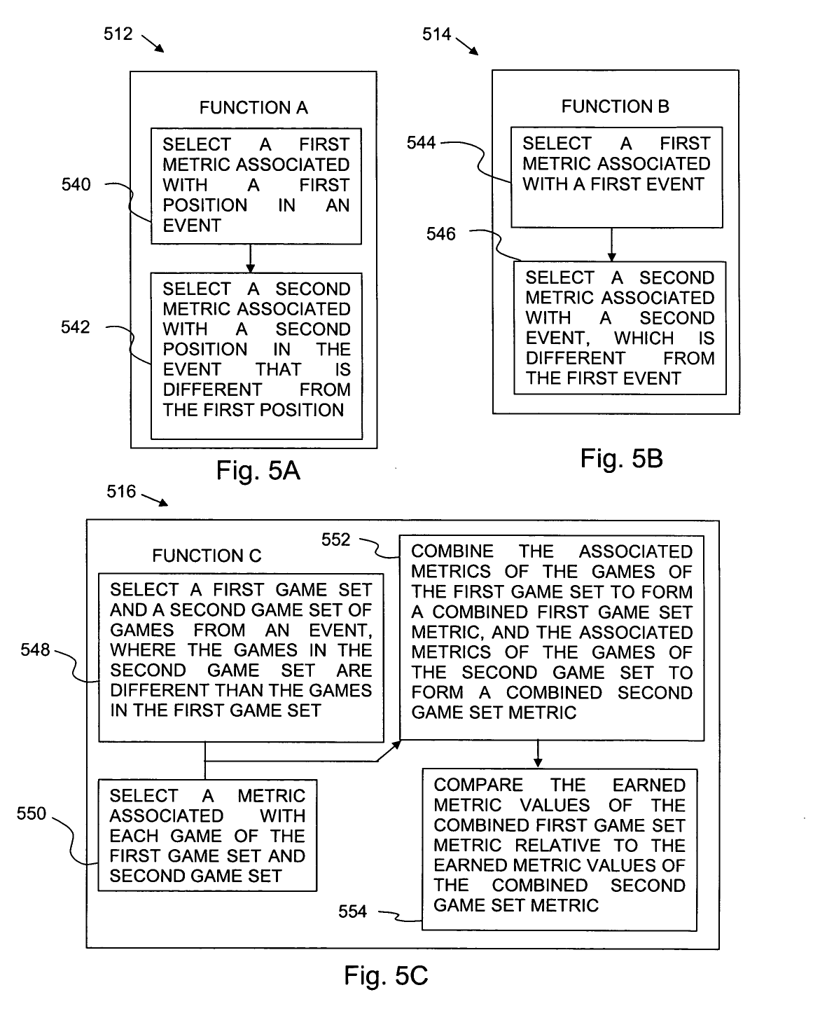

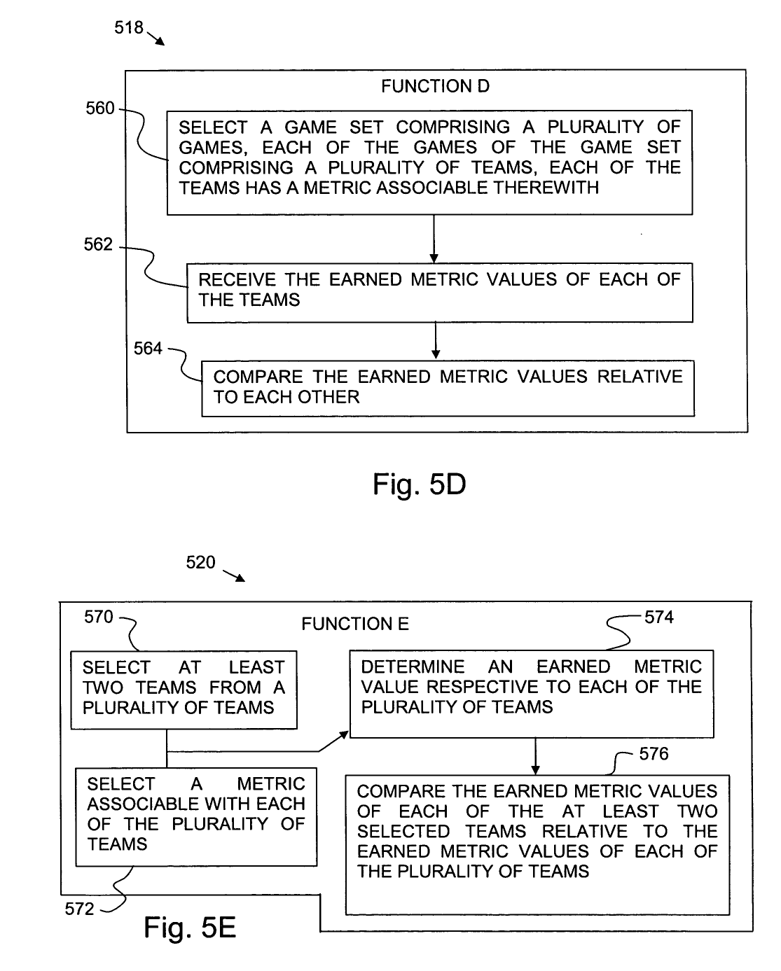

With reference to FIG. 5 and another embodiment according to the invention, a system for wagering 500 includes a processor 510 that is operable to perform functions that may determine a wager according to embodiments of the invention. The processor 510 may be a commercially available hardware package, software package, or combination thereof, that may perform as indicated. The processor 510 may determine the wager by selecting from FUNCTION A (512), FUNCTION B (514), FUNCTION C (516), FUNCTION D (518), and FUNCTION E (520) and performing at least one of the same. FUNCTION A (512), FUNCTION B (514), FUNCTION C (516), FUNCTION D (518), and FUNCTION E (520) are shown in more detail respectively in FIGS. 5A-5E. The processor 510 may also determine the wager status for a wager, as shown in block 522.

The processor 510 may also communicate with, over or through a network 530. A suitable network 530 may include any of commercially available local area networks, wide area networks, wireless networks, the internet, cellular wireless services, digital wireless networks, switched networks, combinations of two or more thereof, and the like. In one embodiment, the network 530 further may be based on internet protocol (IP), java, and/or other suitable protocol or language.

The processor 510 may communicate through the network 530 to one or more bettors 560. In one embodiment, the wager status that is determined in block 522 may be communicated to one or more of the bettors 560. In alternative embodiments, the communication between at least one of the bettors 560 and the processor 510 further may include wager-forming or wager-determining selections. Suitable wager-forming or wager-determining selections may include in one embodiment, for example, the boundary for the plurality of participants, teams, games, combinations thereof, and the like that form limits of the wager. This plurality of participants, teams, games, combinations thereof, and the like may be referred to sometimes herein as a “pool” for ease of expression. In one embodiment, suitable wager-forming or wager-determining selections may include, for example, the particular selections of participants, teams, games, combinations thereof, and the like by one of the bettors 560 from the above-identified plurality or pool. Other suitable wager-forming or wager-determining selections may include the metric, or in the case of a combined metric—the metrics, that are to be measured and compared to determine the wager status. Here and elsewhere in the specification the use of the term metric may include, imply and/or indicate a “combined metric.”

In one embodiment, the processor 510 may communicate with a financial institution 562 and, for example, make transactions therewith. Further, the processor 510 may be further operable to exchange a payment amount or transact with at least one of the bettors 560 based on a determined wager status. That is, the processor 510 may authorize or execute a payment amount to a winning better or credit a bettor account, and in another instance may receive payment from a bettor or debit a bettor account. The processor 510 may coordinate the transaction with one of the bettors 560 and with the financial institution. Suitable financial institutions may include banks, credit companies, savings and loans, brokerages, online financial service companies such as PAYPAL, located in San Jose, Calif. and owned by eBay Inc., also of San Jose, Calif.

FUNCTION A (512) may include selecting a first metric associated with a first position in an event 540. FUNCTION A (512) may include further selecting a second metric associated with a second position in the event that may be different from the first position 542.

FUNCTION B (514) may include selecting a first metric associated with a first event 544. FUNCTION B (514) may include further selecting a second metric associated with a second event that may be different from the first event 546.

FUNCTION C (516) may include selecting a first game set and a second game set 548. The first game set may include games from an event. The second game set also may include games from the same event. The two games in the second game set may be different than the games in the first game set. FUNCTION C (516) may include further selecting a metric associated with each game of the first game set and the second game set 550. The associated metrics of the games for each of the first and second game sets may be combined for each game set to form respective combined game set metrics 552. The combined first game set metric may be compared relative to the combined second game set metric to determine a wager status for the bettor relative to the wager 554.

FUNCTION D (518) may include selecting a game set that includes a plurality of games 560. Each of the games of the game set includes a plurality of teams. A metric is associated with each team of the plurality of teams. After each game has been played and the metric has been generated for each of the teams playing the game, the earned metric value for the selected metric from each team is received 562. The earned metric values, once received, may be compared relative to each other 564. The wager status may be determined based on that comparison 566. For example, the comparison may be a ranking or finishing order of the teams based on the earned metric values. The bettor may have specified in the wager that one particular team would have the highest earned metric value and another particular team would have the second highest earned metric value. If the teams chosen, picked or selected by the bettor during the wager determination rank in the finishing order as predicted and wagered by the bettor, then the wager status may be that the bettor wins and may not be paid a predetermined payment amount. If the teams do not perform as predicted and wagered by the bettor, the bettor's wager status may be such that the bettor loses and may not receive a payment amount.

FUNCTION E (520) may include selecting at least two teams from a plurality of teams 570 (E.g., a pool of teams). The pool of teams may be determined by a bettor, or alternatively may be pre-determined or provided by a house. Also included may be selecting a metric associable with each team that make up the plurality of teams 572. An earned metric value for the selected metric from step 572 may be determined 574 for each of the teams. The earned metric values of the selected teams are compared against the earned metric values of each of the total aggregate of teams in the plurality of teams 576. That comparison may be used to determine the wager status 514. In an alternative embodiment, participants and the like may be used rather than or in addition to teams, or the bettor must select two teams, the bettor must select three teams, the bettor must select four teams, the bettor must select five teams, the bettor must select six teams, or the bettor must select seven teams. In yet another alternative embodiment, the bettor must select more than seven teams.

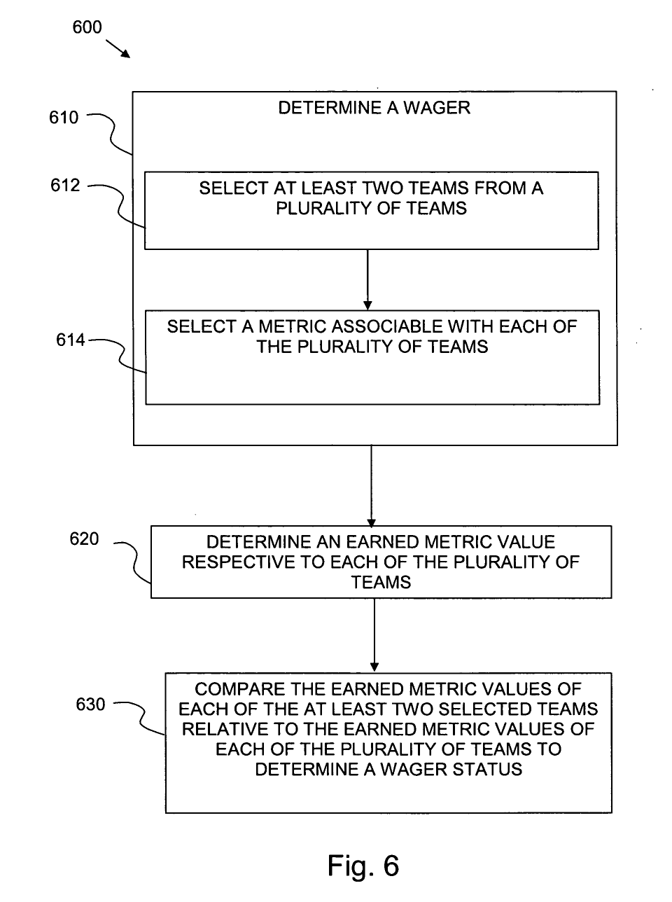

A preferred embodiment of the present invention is a method 600 that may be described with reference to the block diagram shown in FIG. 6. The method of wagering 600 may include determining a wager (step 610). Determining a wager (step 610) may include selecting at least two teams from a plurality of teams (step 612), and selecting a metric associable with each of the plurality of teams (step 614). The method further may include determining an earned metric value respective to each of the plurality of teams (step 620), and determining a wager status by comparing the earned metric values of each of the at least two selected teams relative to the earned metric values of each of the plurality of teams (step 630). In an alternative embodiment, participants may be used rather than teams.

In one embodiment, the bettor, the house, a designated third party, or a combination of two or more thereof may determine the pool or plurality of participants, teams, games, game sets, events, and the like may be selected.

### EXAMPLES

### Example 1

Forming a wager by selecting games in an event, selecting participants in the selected games, and selecting a metric associable with the participants. Determining wager status by comparing the selected participant's earned metric value against like metric values earned in the event by all the participants in the selected games.

In a dog racing scenario, six dog participants (Dogs A-F) are scheduled to run in Race 1 and seven dog participants (Dogs G-M) are scheduled to run in Race 2 on a particular day. Race 1 are run on the same track as Race 2, or on another, different track. Two dogs (Dog B and Dog H) are selected by a bettor as being likely to have the fastest lap times of all the dogs (Dogs A-M) running that day. The selected metric is the fastest lap time. The games or races (Race 1 and Race 2) are run and the dogs each earn a corresponding lap time (earned metric value).

The dogs A-M are ranked or ordered by their earned metric value (lap time). If the bettor-selected dogs (Dog B and Dog H) are the fastest two dogs (e.g., ranked 1^{st} and 2^{nd}) based on lap times, then the wager status is a win for the bettor. If neither Dog B or Dog H, or only one of Dog B and Dog H, are among the fastest two dogs, then the wager status is a lose for the bettor. A wagered amount is paid to the winner by the loser according to the wager status.

### Example 2

Forming a wager by selecting a plurality of games in an event, a set or plurality of teams playing in the games (not necessarily against each other), and a metric associable with each team in the plurality of games. Determining wager status by comparing the selected team's earned metric value against metrics earned by each of the teams in the plurality.

A total of 26 football teams, identified as teams A-Z compete in 13 games of two teams each. Three teams (Teams C, E and H) are selected from the group of teams A-Z. The metrics selected is the highest total points per team per game in the period. The thirteen games are played by the twenty-six teams. The earned metrics are established by the game play, that is, each team may earn its points during each game played with one other team. The teams are ranked against each other based on the points scored metric. If, in this example, pre-selected Teams C, E and H have the highest points scored from among all twenty-six of the Teams A-Z, then the wager status is a winning wager status for the bettor who selected Teams C, E and H and the metric of highest scoring teams.

In summary, for a given period of time, a group of football teams (26 teams) compete in a predetermined number of games (13 games). Of the group of football teams competing, a number of football teams are pre-selected (three teams) and identified (Teams C, E and H). A metric associable with the pre-selected teams is selected (most points scored). The games are played and the wager status is determined.

### Example 3

Comparison between non-similar performance statistic metrics in similar events (the metric comparison: wins to distance). Setting a predetermined value for a performance statistic metric relative to another dissimilar performance statistic metric.

A win by each team from the pre-selected first group of teams (Teams A, B, C and D) will be compared to the sum of the earned passing yardage combined from a second group of teams (Teams E, F, G and H). For each win of the teams from the pre-selected first group, the total yardage of the second group earned must meet or exceed 500 passing yards. That is, if Team A and Team D each win, for a total of 2 wins, the total passing yardage of all of the teams of the second group must be more than 1000 yards (500 yards×2) for the wager status to be considered winning.

### Example 4

Comparison between non-similar performance statistic metrics in non-similar events (the metric comparison: wins to goals)

A predetermined value may be set for a performance statistic relative to another. In this instance each win by Team A in event A, will be compared to the number of goals scored by Team B in event B, where event A and event B are of differing types (e.g., event A is basketball, and event B is soccer).

### Example 5

Comparison between aggregates of non-similar performance statistic metrics in similar event groups (the combined metric comparison: points to points)

The sum of all the points scored by Team A in event A and Team B in event B, will be compared to the sum of all points scored by Team C in event A and Team D in event B.

### Example 6

Comparison between aggregates of non-similar performance statistic metrics in aggregates of non-similar event groups (the combined metric comparison: points to points)

The sum of all the points scored by Team A in event A and Team B in event B, will be compared to the sum of all points scored by Team C in event C and Team D in event D.

### Example 7

Comparison between aggregates of non-similar performance statistic metrics in a single event (the combined metric comparison: distance to distance)

The sum of the distance gained by the wide receiver and the half back for Team A in event A during a single game is compared to the sum of the distance gained by the wide receiver and the half back for Team B in event A during the same game.

### Example 8

Comparison between aggregates of similar performance statistic metrics in a single event (the combined metric comparison: number occurrence to number occurrence)

In a basketball game event, the number of successful three-point shots is compared to the number of successful lay-up shots.

### Example 9

A method of determining a wager

A list of teams of one event is provided as well as a game set that includes games in which the listed teams compete. The game set includes all National Football League (NFL) games in a week played during a regular season where the game includes as a participating team one of: the Cincinnati Bengals, the Cleveland Browns, the Dallas Cowboys and the Minnesota Vikings. The teams selected are included in the terms for the wager. The total number of points scored by each team is selected as a metric. The wager is determined to be pari-mutual based on finishing order of the selected four teams based on the metric. Interested bettors choose payment amounts, which are combined to form a payment pool from which the winnings will be paid, less the house commission.

As each new bettor adds the payment amount to the pool, the expected payout information is revised by calculating each bet combination. The wager is closed and at the end of the week, all the games of the wager are played and the wager ends. At the end of the wager, the wager status of each bettor is determined by comparing the earned metric values of each team and ranking the teams in a finishing order based on the earned metric value. That is, the ranking the four selected teams in the finishing order is based on the earned metric value, where, for example, the metric is total points scored. The bettor's wager on finishing order is compared relative to the actual finishing order. The payout is made to winning bettors from the payment pool. If a particular bettor had bet the Browns to win, and the Browns had the highest relative earned metric value (i.e., highest total score), then that particular bettor would have won.

### Example 10

Comparison between similar performance statistic metrics in non-similar events (the metric comparison: points to points)

If football games average 21 points per team per game in a playoff game, hockey averages 3 points per team per game in a playoff game, so each hockey point may convert to 7 football points.

### Example 11

Comparison between non-similar performance statistic metrics in similar events (the metric comparison: distance to distance)

Average rushing over a previous season for a half back is 1000 yards. Average yards gained via passing for a QB over a previous season is 750 yards. To compare current season metrics of the half back to the QB, a 7.5 to 10 ratio may be used.

The processes and embodiments described herein are examples of structures, systems and methods having elements corresponding to the elements of the invention recited in the claims. This written description may enable those skilled in the art to make and use embodiments having alternative elements that likewise correspond to the elements of the invention recited in the claims. The intended scope of the invention thus includes other structures, systems and methods that do not differ from the literal language of the claims, and further includes equivalents of other structures, systems and methods with insubstantial differences from the literal language of the claims.

1. A method of wagering, comprising:
determining a wager by:
selecting at least two teams from a plurality of teams, and
selecting a metric associable with each of the plurality of teams;
determining an earned metric value respective to each of the plurality of teams; and
determining a wager status by comparing the earned metric values of each of the at least two selected teams relative to the earned metric values of each of the plurality of teams.

2. The method as defined in claim 1, wherein the earned metric value is the total number of points scored per game.

3. The method as defined in claim 1, wherein the earned metric value comprises time, distance, or number of predetermined occurrences.

4. The method as defined in claim 1, wherein each team of the plurality of teams participate in a single event.

5. The method as defined in claim 4, wherein the event comprises a predetermined plurality of games, and the step of determining the earned metric values includes measuring the metric for each of the plurality of the teams for the plurality of games.

6. The method as defined in claim 4, wherein the event comprises archery, badminton, baseball, basketball, bobsledding, bowling, boxing, canoeing, croquet, curling, cycling, diving, equestrian, fencing, field hockey, figure skating, fishing, football, freestyle skating, golf, gymnastics, ice hockey, luge, martial arts, motor sports, power-boating, rowing, rugby, running, sailing, skiing, skydiving, soccer, speed skating, synchro swimming, table tennis, tennis, track and field, water polo, weight lifting, wrestling, or combinations of two or more thereof.

7. The method as defined in claim 4, wherein the event is a non-human event selected from horse racing, dog racing, robot wars, insect fighting, combinations of two or more thereof, and the like.

8. The method as defined in claim 1, wherein the metric is a combined metric, and the step of determining the metric comprises combining a first metric that is associated with a first position on the team in a game of an event with a second, different metric that is associated with a second position on the team in the game of the event.

9. The method as defined in claim 1, further comprising determining a payment amount.

10. The method as defined in claim 9, further comprising paying the payment amount to the bettor if the bettor has won the wager based on the wager status, or collecting the payment amount from the bettor if the bettor has lost the wager based on the wager status.

11. The method as defined in claim 9, further comprising providing the wager to a bettor.

12. The method as defined in claim 1, further comprising selecting the teams that form the plurality of teams.

13. The method as defined in claim 1, wherein the step of selecting the at least two teams comprises selecting two teams.

14. The method as defined in claim 1, wherein the step of selecting the at least two teams comprises selecting three teams.

15. The method as defined in claim 1, wherein the step of selecting the at least two teams comprises selecting four teams.

16. The method as defined in claim 1, wherein the step of selecting the at least two teams comprises selecting five teams.

17. The method as defined in claim 1, wherein the step of selecting the at least two teams comprises selecting six teams.

18. The method as defined in claim 1, wherein the step of determining the wager further comprises indicating the finishing order of each of the at least two teams selected.

18. The method as defined in claim 1, wherein the step of determining the wager further comprises selecting a range of placement in a finishing order for each of the at least two teams, and wherein the step of determining the wager status comprises determining whether the at least two teams fall within the selected range.

19. A method of wagering, comprising:
determining a wager by:
selecting at least two participants from a plurality of participants, and
selecting a metric associable with each of the plurality of participants;
determining an earned metric value respective to each of the plurality of participants; and
determining a wager status by comparing the earned metric value of each of the selected at least two participants relative to the earned metric values of each the plurality of participants.

20. The method as defined in claim 19, wherein the earned metric value is the total number of points scored per game.

21. The method as defined in claim 19, wherein the earned metric value comprises time, distance, or number of predetermined occurrences.

22. The method as defined in claim 19, wherein all the participants of the plurality of participants participate on differing teams in a single event.

23. The method as defined in claim 22, wherein the event comprises a predetermined number of games, and the step of determining the earned metric values includes measuring the metric for each of the plurality of the participants for the predetermined number of games.

24. The method as defined in claim 22, wherein the event comprises archery, badminton, baseball, basketball, bobsledding, bowling, boxing, canoeing, croquet, curling, cycling, diving, equestrian, fencing, field hockey, figure skating, fishing, football, freestyle skating, golf, gymnastics, ice hockey, luge, martial arts, motor sports, power-boating, rowing, rugby, running, sailing, skiing, skydiving, soccer, speed skating, synchro swimming, table tennis, tennis, track and field, water polo, weight lifting, wrestling, or combinations of two or more thereof.

25. The method as defined in claim 22, wherein the event is a non-human event selected from horse racing, dog racing, robot wars, insect fighting, combinations of two or more thereof, and the like.

26. The method as defined in claim 19, wherein the metric is a combined metric, and the step of determining the combined metric comprises combining a first metric that is associated with a first position of a first participant in a game of an event with a second, different metric that is associated with a second position of a second participant on the team in the game of the event.

27. The method as defined in claim 19, further comprising selecting the participants that form the plurality of participants.

28. The method as defined in claim 19, wherein the step of selecting the at least two participants comprises selecting two participants.

29. The method as defined in claim 19, wherein the step of selecting the at least two participants comprises selecting three participants.

30. The method as defined in claim 19, wherein the step of selecting the at least two participants comprises selecting four participants.

31. The method as defined in claim 19, wherein the step of selecting the at least two participants comprises selecting five participants.

32. The method as defined in claim 19, wherein the step of selecting the at least two participants comprises selecting six participants.

33. The method as defined in claim 19, wherein the step of determining the wager further comprises indicating the finishing order of each of the at least two participants selected.

34. The method as defined in claim 19, wherein the step of determining the wager further comprises selecting a range of placement in a finishing order for each of the at least two participants, and wherein the step of determining the wager status comprises determining whether the at least two participants fall within the selected range.

35. A system for wagering, comprising:
means for determining a wager comprising,
means for selecting a team from a plurality of teams or a participant from a plurality of participants, and
means for selecting a metric associable with the selected team or participant;
means for determining the earned metric value of each of the plurality of teams or each of the plurality of participants; and
means for determining a wager status by comparing the earned metric value of the selected team or participant relative to respective earned metric value of each of the plurality of teams or each of the plurality of participants.

36. A system for wagering, comprising:
a processor operable to determine a wager, the wager being determinable by:
determining a wager comprising,
selecting a team from a plurality of teams or a participant from a plurality of participants, and
selecting a metric associable with the selected team or participant;
determining the earned metric value of each of the plurality of teams or each of the plurality of participants; and
determining a wager status by comparing the earned metric value of the selected team or participant relative to respective earned metric value of each of the plurality of teams or each of the plurality of participants; and
the processor being further operable to determine a wager status for a bettor relative to the wager.

37. A method for conducting a business comprising wagering, the method comprising:
determining a wager comprising,
selecting a team from a plurality of teams or a participant from a plurality of participants, and
selecting a metric associable with the selected team or participant;
determining the earned metric value of each of the plurality of teams or each of the plurality of participants; and
determining a wager status by comparing the earned metric value of the selected team or participant relative to respective earned metric value of each of the plurality of teams or each of the plurality of participants; and
accepting the wager with a bettor;
determining a wager status for a bettor relative to the wager; and
exchanging payment with the bettor based on the determined wager status.
